(19) United States
(12) Patent Application Publication
(10) Pub. No.: US 2005/0142398 A1
(43) Pub. Date: Jun. 30, 2005

(54) Prevention of chromia-induced cathode poisoning in solid oxide fuel cells (SOFC)

(75) Inventors: Kenneth Walter Browall, Niskayuna, NY (US); Chellappa Balan, Niskayuna, NY (US); Nadathur Seshadri Hari, Bangalore (IN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/745,355

(22) Filed: Dec. 24, 2003

(51) Int. Cl. H01M 8/04; H01M 8/12

(52) U.S. Cl. 429/13; 429/26; 429/30

(57) ABSTRACT

A method is provided for increasing the life expectancy of a solid oxide fuel cell by preventing cathode poisoning due to chromium volatilization. Chromium hydroxide and oxyhydroxide formation and evaporation are prevented by continuously drying the cathode feed gas to low moisture levels. Power generation configurations that minimize the energy penalty associated with cathode gas drying are also disclosed.

### BACKGROUND OF THE INVENTION

The invention relates to a fuel cell system. More particularly, the invention relates to integration of a moisture removal system with the oxidant inlet of a solid oxide fuel cell (SOFC) system.

Solid oxide fuel cells (SOFCs) are devices that produce energy, usually electricity, from a variety of fuels using an electrochemical reaction. Oxygen transfer through the electrolyte, necessary for efficient energy conversion, is greatly accelerated at temperatures above 700° C. The overall fuel to electric efficiency in SOFCs may be as high as 90% and is not limited by classical thermodynamics for heat engines (Carnot cycle). Due to their high exhaust gas temperature, SOFCs have the ability to cogenerate heat and electric power, with the balance in favor of electric power. Hybrid power generation systems integrating the SOFCs and Turbines can have very high overall system efficiencies.

SOFCs may be tubular or planar in assembly. The key components of an SOFC are: anode, cathode, electrolyte, interconnects, manifold and seals. The cathode is largely exposed to a hot, oxidant environment, and is generally called the air or oxygen electrode. The temperature of the cathode feed gas is usually about 400° C. or higher. Similarly, the anode is exposed to the fuel and is called the fuel electrode. The interconnects interface with the anode on the fuel side and with the cathode on the air side and are usually made using oxidation resistant, heat resistant materials such as lanthanum chromite, lanthanum strontium chromite, ferritic stainless steels and chromium base alloys. Ferritic stainless steels typically contain at least 20 wt % of chromium.

Highly oxidizing conditions prevail at the cathode at elevated temperatures and high oxygen partial pressures. These, along with humidity and atmospheric moisture may oxidize chromium present in interconnects to chromium oxides or hydroxide or oxyhydroxide that grow as cathode scales and can vaporize to poison or deactivate the cathode. Cathode scales may grow to a thickness of tens of microns after exposure for thousands of hours in the SOFC environment in an intermediate temperature range. Chromium hydroxide and oxyhydroxide are particularly volatile and may degrade the cathode. To enhance life expectancy and operational efficiency of the SOFC cathode degradation must be eliminated.

Current methods for minimizing cathode degradation in SOFCs are not adequately developed and limit the useful operating life of the SOFCs. The problem may be minimized or eliminated by frequent maintenance or cathode scale removal. This may result in cell stoppage and induce a significant energy penalty associated with the power generation cycle. Alternatively, non-chromium containing alloys and ceramic materials with non-volatile chromium have been employed in interconnects. However, these materials are expensive, brittle, weak under tensile forces, or have high resistive losses making them unsuitable for interconnects applications. Many SOFC stacks employ interconnects and components made from alloys containing chromium and few suitable replacement materials are available. The problem of high cathode degradation rates has not been solved. Therefore, what is needed is a method for preventing poisoning (or degradation) of chromium cathodes. What is also needed is a method for removal of moisture (or water vapor) from the fuel cell oxidant supply. What is also needed is the applicability of such method in a continuous manner without stoppage or interruption of fuel cell supply. What is also needed is a system to regenerate or recuperate a desiccant bed (or drying agent) employed in the method by using the hot exhaust gases (usually air; which would otherwise have been wasted) produced by the fuel cell. What is also needed is a system that minimizes the energy penalty associated with drying the inlet oxidant.

### BRIEF SUMMARY OF THE INVENTION

The present invention addresses these and other needs by providing system configuration and methods for removing moisture from a fuel cell oxidant supply and a methods for moisture removal that may be applied continuously without stoppage or interruption in fuel cell supply. It also provides a method to regenerate the desiccant bed using hot exhaust gases produced in the SOFC thus minimizing the energy penalty.

Accordingly, one aspect of the invention is to provide a fuel cell system. The fuel cell system comprises: at least one fuel cell having at least one oxidant inlet; and a moisture removal system in flow communication with the at least one oxidant inlet to remove moisture from an oxidant provided to the oxidant inlet.

A second aspect of the invention is to provide a method for removing moisture in a fuel cell system. The method comprises: providing at least one oxidant flow to the fuel cell system; directing at least a portion of the oxidant flow through a moisture removal system; and removing at least a portion of moisture from the oxidant flow.

A third aspect of the invention is to provide a solid oxide fuel cell system. The fuel cell system comprises: at least one fuel cell having at least one oxidant inlet; a moisture removal system in flow communication with the at least one oxidant inlet to remove moisture from an oxidant provided to the oxidant inlet; an anode; a cathode and an electrolyte.

A fourth aspect of the invention is to provide a method for removing moisture in a fuel cell system. The method comprises: connecting the moisture removal system to the fuel cell; allowing exchange of heat between moisture and drying species; allowing sufficient dwell time between the drying species and moisture; conveying dry cathode feed gas into the fuel cell and regenerating the moisture removing elements (desiccant) using hot exhaust air from the fuel cell along at least one hot air inlet.

These and other aspects, advantages, and salient features of the present invention will become apparent from the following detailed description, the accompanying drawings, and the appended claims.

### BRIEF DESCRIPTION OF THE DRAWINGS

Referring now to the figures wherein like elements are numbered alike:

FIG. 1 is a schematic view illustrating one embodiment of a fuel cell stack showing its components;

FIG. 2 is a schematic view illustrating an embodiment of a fuel cell system including a moisture removal system (along with desiccant regeneration system) that is a physical absorption system;

FIG. 3 is a schematic view illustrating an embodiment of a fuel cell system including a moisture removal system (along with desiccant regeneration system) that is a chemical absorption system;

FIG. 4 is a schematic view illustrating an embodiment of a vapor absorption refrigeration system for moisture removal; and

FIG. 5 is a schematic view illustrating an embodiment of a vapor compression refrigeration system for moisture removal.

### DETAILED DESCRIPTION OF THE INVENTION

In the following description, like reference characters designate like or corresponding parts throughout the several views shown in the figures. It is also understood that terms such as “top,” “bottom,” “outward,” “inward,” and the like are words of convenience and are not to be construed as limiting terms.

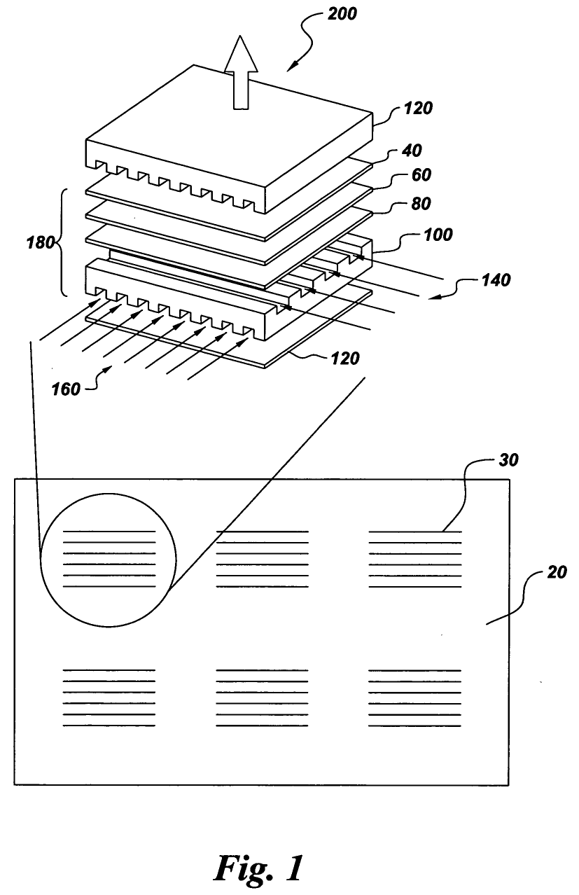

Referring to the drawings in general and to FIG. 1 in particular, it will be understood that the illustrations are for the purpose of describing a preferred embodiment of the invention and are not intended to limit the invention thereto.

Fuel cells convert gaseous fuels (hydrogen, natural gas, gasified coal) via an electrochemical process directly into electricity. Their efficiencies are not limited by the Carnot cycle of a heat engine, and the pollutant output from fuel cells is many magnitudes lower than from conventional technologies. A fuel cell operates like a battery, but does not need to be recharged, and continuously produces power when supplied with fuel and oxidant.

A Solid Oxide Fuel Cell (SOFC), is regarded as an extremely efficient and versatile power-generating device. The current operating temperature of an SOFC is around 800° C. and developmental efforts to reduce the operating temperature are in progress. SOFCs are fuel flexible and can operate on multiple fuels, including carbon-based fuels. This results in potentially high overall fuel to electric efficiency of around 60% for simple cycles and higher efficiency for hybrid systems. Due to their high exhaust gas temperature they have the ability to cogenerate heat and electric power whereas hybrid systems maximize the electrical efficiency.

The high operating temperature of SOFC is mainly dictated by slow oxygen transfer rates through the electrolyte at lower temperatures. This factor, combined with the multi-component nature of the fuel cell and the required life expectancy of several years severely restricts the choice of materials for cell and manifold components. Each material used not only has to function optimally in its own right but has to be viewed in conjunction with the other cell components. The common requirements of all cell components (i. e. including, but not limited to, electrolyte, anode, cathode, interconnects, manifold and seals) are:
(i) chemical stability in fuel cell environments (partial pressure of oxygen exceeds 20 kPa on the cathode side and is less than 10⁻¹⁷ on the anode side) and compatibility with other cell components;
(ii) phase and microstructural stability;
(iii) minimum thermal expansion mismatch between various cell components (laminated structure);
(iv) for structural components, reasonable strength and toughness at the cell operating temperature, as well as reasonable thermal shock resistance;
(v) low vapor pressure to avoid loss of material and
(vi) amenability to fabrication at competitive costs.

The cathode is a particularly important component of an SOFC. The atmosphere at the cathode is highly oxidizing. The common cathode material used in SOFC systems is Strontium (Sr) doped La-manganite (LSM), a p-type semiconductor. Doping LaMnO₃ with lower valent cations enhances the electronic conductivity. The extent and nature of the dopants dictates the electronic conductivity and the electrode reaction rates. A change of the morphology of the cathode layer with time, blocking of reaction sites or interfacial reaction between cathode and electrolyte during operation, all limit the life of SOFCs and need to be minimized. A number of other materials are also used, such as La—Sr-cobaltite, a material with much higher electronic conductivity, and in addition high ionic conductivity, but with the disadvantages (compared to LSM) of a high thermal expansion coefficient and lower stability due to interface reactions with the electrolyte.

The electro-chemical performance of an SOFC cathode is greatly influenced by the materials characteristics of the cell interconnects. The interconnects interface with the anode on the fuel side and with the cathode on the air side and are usually made using oxidation resistant, low resistive loss, heat resistant materials such as ferritic stainless steels, chromium based alloys, lanthanum chromite, and lanthanum strontium chromite. Ferritic stainless steels typically contain about 26 wt % of chromium. In SOFC operation, highly oxidizing conditions prevail at the cathode at elevated temperatures and high oxygen partial pressures. These, along with humidity and atmospheric moisture may oxidize or hydrolyze chromium present in interconnects to chromium oxides or hydroxide or oxyhydroxide that deposit as cathode scales and poison or deactivate the cathode. Cathode scales may grow to a thickness of tens of microns after exposure for thousands of hours in the SOFC environment in an intermediate temperature range. Chromium hydroxide or oxyhydroxide are particularly volatile and may degrade the cathode. To enhance life expectancy and operational efficiency of the SOFC cathode degradation due to moisture must be eliminated. This must be done in a manner which minimizes the efficiency penalty.

The current invention discloses a method to dry the moist cathode feed gas without sacrificing the efficiency. This prevents oxidation and hydrolysis of chromium present in the interconnect material. Chromium oxides and hydroxides would normally deposit on the cathode and degrade it. Such cathode degradation is prevented by the current invention that increases the life expectancy of a fuel cell by preventing chromium oxides and hydroxide formation that poisons an SOFC cathode.

According to one embodiment of the present invention a fuel cell system 20 comprises at least one fuel cell 30 having at least one anode 40, an electrolyte 60, a cathode 80, an interconnect 100 and a seal 105, as generally shown in FIG. 1. The cathode 80 and the interconnect 100 are in intimate electrical contact via contact 90. A fuel cell stack is obtained by repeated stacking of repeating unit 180 that comprises an anode 40, electrolyte 60, cathode 80, cathode-interconnect contact 90 and interconnect 100. The fuel cell is encased between extreme end plates 120.

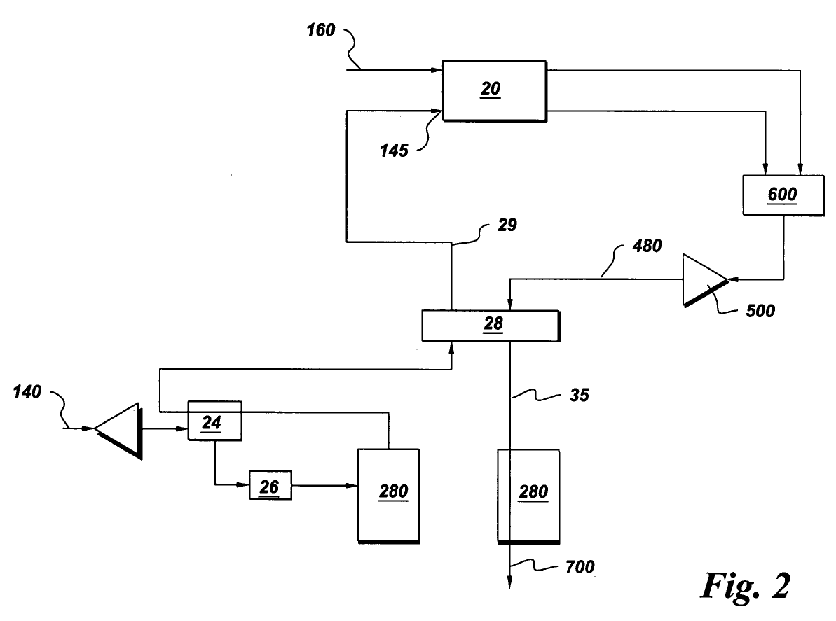

Interconnect 100 comprises, on the cathode side, a system for oxidant flow 140 that consists of oxidant inlets 145 that convey the cathode feed gas (or oxidant) to the cathode 80; and fuel flow conduits 160 to convey the fuel to the anode 40. As generally shown in FIG. 2, heat exchangers 24 and 26 cool the moist, cathode feed gas to a low temperature. The cool, moist air is dried by passing through the moisture removal system 280 which dries the air. The hot, dry air is passed through the first heat exchanger 24 where it receives a portion of the heat from the incoming moist air 140. Downstream of heat exchanger 24, the hot dry air is conveyed to recuperator 28 where its temperature is substantially increased by absorbing heat from hot turbine exhaust gases 480 exiting from gas turbine 500. The post-recuperator hot dry air 29 is input into the SOFC fuel cell system 20 via oxidant inlet 145. The current produced on operating the fuel cell emerges from the SOFC along current direction 200, as generally shown in FIG. 1. While the systems of FIGS. 2, 3 and 4 are each shown as hybrid configurations, this is not a limitation of the invention. For example, the moisture removal system 220 can be configured to work with any stand-alone fuel cell system prone to chromia induced cathode poisoning.

Fuel cell system 20 is maintained in driving contact with combustor 600 and hot gases emerging therefrom are used to drive gas turbine 500 for power generation purposes. A portion of the exhaust gases 480 exiting gas turbine is conveyed to recuperator 28 to preheat the hot dry air 29 input into the fuel cell system 20 via oxidant inlet 145. Another portion of the waste heat from the turbine exhaust 480, the recuperator exhaust 35 is conveyed to the dryer 280 in the moisture removal system 220 so as to heat a desiccant bed and revitalize desiccant 460.

In one embodiment of the fuel cell system 20 the moisture absorption system 220, is a physical absorption system 280 as discussed above and generally shown in FIG. 2. The physical absorption system 280 comprises a desiccant or drying agent, such as but not limited to, indicating and non-indicating type silica gels, molecular sieves, alumino silicates, activated carbon or rice husks, with which physical absorption system 280 dries the incoming cathode feed gas 140 and is revitalized by the recuperator exhaust 35 exiting from recuperator 28. The spent portion 700 of the recuperator exhaust 35 that is not used for desiccant regeneration or other purposes, is released into the environment

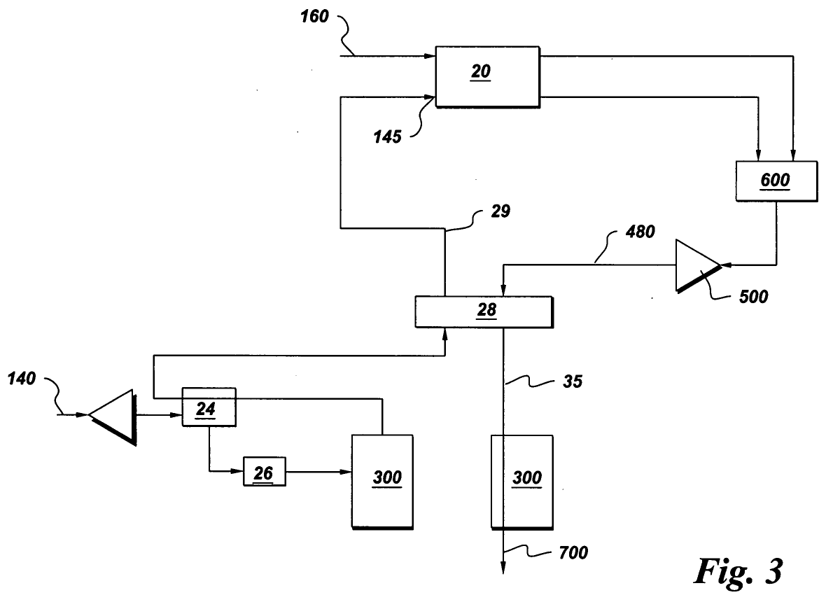

In another embodiment, the moisture absorption system 220 is a chemical absorption system 300 as generally shown in FIG. 3. As generally shown in FIG. 3, heat exchangers 24 and 26 cool the moist, cathode feed gas to a low temperature. The cold, moist air is dried by passing through the chemical absorption system 300 that dries the air. The cold, dry air is passed through the first heat exchanger 24 where it receives a portion of its heat form the incoming moist air 140. Downstream of heat exchanger 24, the hot dry air is conveyed to recuperator 28 where its temperature is substantially increased by absorbing heat from hot turbine exhaust gases 480 exiting from gas turbine 500. The post-recuperator hot dry air 29 is input into the SOFC fuel cell system 20 via oxidant inlet 145. The current produced on operating the fuel cell emerges from the SOFC along current direction 200, as generally shown in FIG. 1. The chemical absorption system 300 comprises a chemical species known for its strong affinity for water (or moisture), such as but not limited to, sodium-sulfate, calcium chloride, calcium oxide, or a combination thereof. The chemical moieties dry the incoming cathode feed gas 140 and are revitalized by the recuperator exhaust 35 exiting the recuperator 28. The spent portion 700 of the recuperator exhaust 35 that cannot be used for desiccant regeneration or other purposes, is released into the environment.

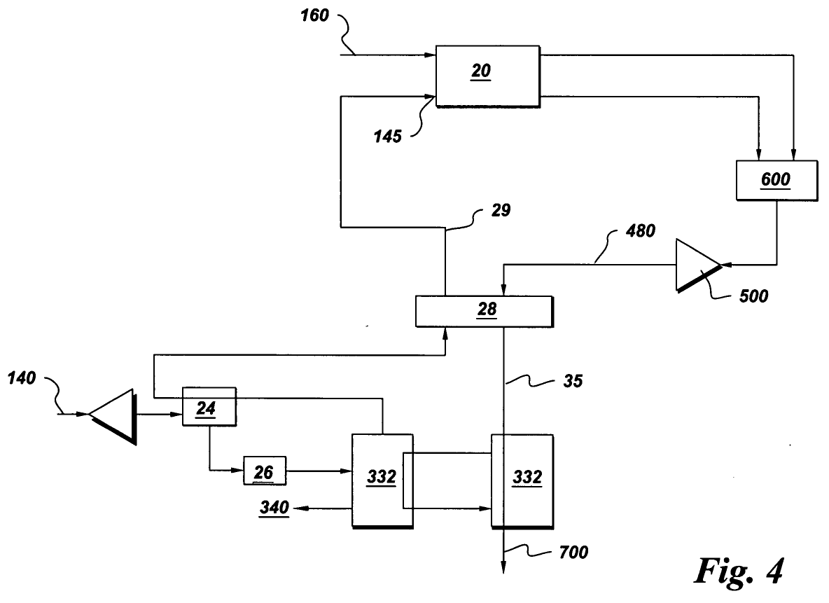

In another embodiment, the moisture system 220 is a condensation system 332. In another embodiment, condensation system 320 comprises a vapor absorption refrigeration system 332 driven by waste heat from the turbine exit. The principles of vapor absorption refrigeration systems are known to the one well versed in the art. The air is dried by cooling the air to low enough temperature that causes condensation of the moisture which is removed from the system 340. As generally shown in FIG. 4, heat exchanger 24 in this case, cools the moist, cathode feed gas to a low temperature. The cool, moist air is dried by passing through condensation system 320 that dries the air. The dry air is passed through the first heat exchanger 24 where it absorbs a portion of the heat from the incoming moist air 140. Downstream of heat exchanger 24, the dry air is conveyed to recuperator 28 where its temperature is substantially increased by absorbing heat from hot turbine exhaust gases 480 exiting from gas turbine 500. The post-recuperator hot dry air 29 is input into the SOFC fuel cell system 20 via oxidant inlet 145. The current produced on operating the fuel cell emerges from the SOFC along current direction 200, as generally shown in FIG. 1.

The spent portion 700 of the exhaust gas 480 that cannot be used to power the vapor absorption refrigeration system 332, in condensate removal or in other requirements, is released into the environment.

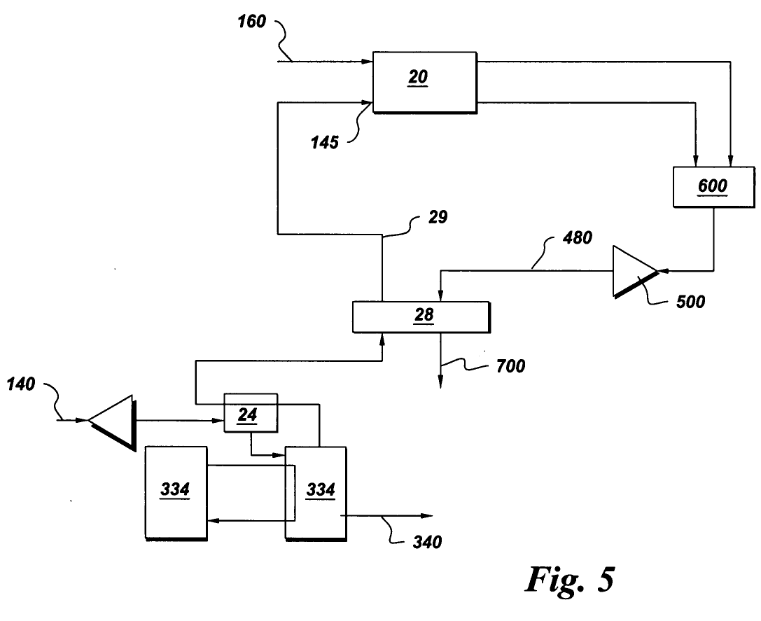

In another embodiment of the claimed invention, the refrigeration system 330 is a vapor compression refrigeration system 334 generally shown in FIG. 5.

In another embodiment of the present invention, a method for removing moisture in a fuel cell system 20 is disclosed. The method comprises: providing at least one oxidant flow 140 to the fuel cell system 20, directing at least a portion of the oxidant flow 140 through a moisture removal system 220; and removing at least a portion of moisture from the oxidant flow 140.

In a third embodiment of the present invention, a solid oxide fuel cell system 20 is disclosed. The said solid oxide fuel cell system 20 comprises at least one fuel cell 30 having at least one oxidant inlet 145; a moisture removal system 220 in flow communication with said at least one oxidant inlet 145 to remove moisture 240 from an oxidant 140 provided to said oxidant inlet 140; an anode 40; a cathode 80 and an electrolyte 60.

In a fourth embodiment of the present invention a method for removing moisture 240 in a fuel cell system 20 is disclosed. The method comprises connecting the moisture removal system 220 to the fuel cell 30, allowing exchange of heat between moisture 100 and drying species (or desiccant 460), allowing sufficient dwell time between the drying species and moisture 240, conveying dry cathode feed gas 145 into the fuel cell 30 and regenerating the moisture removing elements (or desiccant 460) using hot air 480 along at least one hot air inlet 420.

In all embodiments, the claimed invention minimizes the energy penalty associated with drying the inlet oxidant.

While typical embodiments have been set forth for the purpose of illustration, the foregoing description should not be deemed to be a limitation on the scope of the invention. For example, while hybrid systems are depicted, simple systems are also encompassed within this invention. Accordingly, various modifications, adaptations, and alternatives may occur to one skilled in the art without departing from the spirit and scope of the present invention.

1. A fuel cell system comprising:
a) at least one fuel cell having at least one oxidant inlet; and
b) a moisture removal system in flow communication with said at least one oxidant inlet to remove moisture from an oxidant provided to said oxidant inlet.

2. In accordance with claim 1, wherein said fuel cell system a comprises at least one of a simple fuel cell system or a hybrid fuel cell turbine system, or a combined heat and power fuel cell system.

3. In accordance with claim 2, wherein fuel cell system, is a solid oxide fuel cell (SOFC).

4. In accordance with claim 1, wherein said moisture removal system is a moisture absorption system.

5. In accordance with claim 1, wherein said fuel cell system is of planar or tubular configuration.

6. In accordance with claim 5, wherein said fuel cell system is of planar configuration.

7. In accordance with claim 4, wherein said moisture absorption system is selected from the group consisting of physical absorption system and a chemical absorption system.

8. In accordance with claim 4, wherein said moisture absorption system is a condensation system.

9. In accordance with claim 7, wherein said physical absorption system further comprising at least one of silica gel system, molecular sieves, alumino silicates, activated carbon, rice husks, and a combination thereof.

10. In accordance with claim 7, wherein said chemical absorption system further comprising at least one of sodium sulfate, calcium chloride, calcium oxide, or combination thereof.

11. In accordance with claim 8, wherein said condensation system further comprising a refrigeration system.

12. In accordance with claim 11, wherein said refrigeration system comprises at least one refrigerant, said refrigerant comprising at least one of ammonia, freon-12, freon-22, chlorofluorocarbons, hydrochlorofluorocarbons, difluorodichloromethane, 1,1,1,2-tetrafluoroethane, isobutane, liquid carbon dioxide, liquid ethane, and a combination thereof, said refrigeration system comprising at least one of a vapor refrigeration system and a vapor absorption sytem.

13. In accordance with claim 4, wherein said moisture absorption system further comprising at least one hot exhaust outlet for removing hot exhaust from said system.

14. In accordance with claim 13, wherein said hot exhaust outlet is in intimate contact with at least one portion of said moisture absorption system to heat said at least one portion of said moisture absorption system for regeneration.

15. In accordance with claim 8, wherein said condensation system further comprising at least one hot exhaust outlet for removing hot exhaust from said system.

16. In accordance with claim 15, wherein said hot exhaust outlet is in driving contact with at least one portion of said condensation system to power said condensation system.

17. A method for removing moisture in a fuel cell system, said method comprising the steps of:
a) providing at least one oxidant flow to said fuel cell system
b) directing at least a portion of said oxidant flow through a moisture removal system; and
c) removing at least a portion of moisture from said oxidant flow

18. In accordance with claim 17, wherein said moisture removal system is a moisture absorption system.

19. In accordance with claim 18, wherein said moisture absorption system is selected from the group consisting of physical absorption system and a chemical absorption system.

20. In accordance with claim 18, wherein said moisture absorption system is a condensation system.

21. In accordance with claim 19, wherein said physical absorption system further comprising at least one of silica gel system, molecular sieves, alumino silicates, activated carbon, rice husks and a combination thereof.

22. In accordance with claim 19, wherein said chemical absorption system further comprising at least one of sodium sulfate, calcium chloride, calcium oxide, or combination thereof.

23. In accordance with claim 20, wherein said condensation system further comprising a refrigeration system.

24. In accordance with claim 23, wherein said refrigeration system comprises at least one refrigerant, said refrigerant comprising at least one of ammonia, freon-12, freon-22, chlorofluorocarbons, hydrochlorofluorocarbons, difluorodichloromethane, 1,1,1,2-tetrafluoroethane, isobutane, liquid carbon dioxide, liquid ethane, and a combination thereof, said refrigeration system comprising at least one of a vapor refrigeration system and a vapor absorption system.

25. In accordance with claim 18, wherein said moisture absorption system further comprising at least one hot exhaust outlet for removing hot exhaust from said system.

26. In accordance with claim 25, wherein said hot exhaust outlet is in intimate contact with at least one portion of said moisture absorption system to heat said at least one portion of said moisture absorption system for regeneration.

27. In accordance with claim 20, wherein said condensation system further comprising at least one hot exhaust outlet for removing hot exhaust from said system.

28. In accordance with claim 27, wherein said hot exhaust outlet is in driving contact with at least one portion of said condensation system to power said condensation system.

29. A fuel cell system comprising:
a) at least one fuel cell having at least one oxidant inlet;
b) a moisture removal system in flow communication with said at least one oxidant inlet to remove moisture from an oxidant provided to said oxidant inlet;
c) an anode;
d) a cathode and
e) an electrolyte.

30. In accordance with claim 29, wherein fuel cell system comprises at least one of a simple fuel cell system or a hydrib fuel cell turbine system, or a combined heat and power fuel cell system.

31. In accordance with claim 30, wherein fuel cell system, is a solid oxide fuel cell (SOFC).

32. In accordance with claim 29, wherein said moisture removal system is a moisture absorption system.

33. In accordance with claim 29, wherein said fuel cell system is of planar, or tubular configuration.

34. In accordance with claim 33, wherein said fuel cell system is of planar configuration

35. In accordance with claim 32, wherein said moisture absorption system is selected from the group consisting of physical absorption system and a chemical absorption system.

36. In accordance with claim 32, wherein said moisture absorption system is a condensation system.

37. In accordance with claim 35, wherein said physical absorption system further comprising at least one of silica gel system, molecular sieves, alumino silicates, activated carbon, rice husks, and a combination thereof.

38. In accordance with claim 35, wherein said chemical absorption system further comprising at least one of sodium sulfate, calcium chloride, calcium oxide, or combination thereof.

39. In accordance with claim 36, wherein said condensation system further comprising a refrigeration system.

40. In accordance with claim 39, wherein said refrigeration system comprises at least one refrigerant, said refrigerant comprising at least one of ammonia, freon-12, freon-22, chlorofluorocarbons, hydrochlorofluorocarbons, difluorodichloromethane, 1,1,1,2-tetrafluoroethane, isobutane, liquid carbon dioxide, liquid ethane, and a combination thereof, said refrigeration system comprising at least one of a vapor refrigeration system and a vapor absorption system.

41. In accordance with claim 32, wherein said moisture absorption system further comprising at least one hot exhaust outlet for removing hot exhaust from said system.

42. In accordance with claim 41, wherein said hot exhaust outlet is in intimate contact with at least one portion of said moisture absorption system to heat said at least one portion of said moisture absorption system for regeneration.

43. In accordance with claim 36, wherein said condensation system further comprising at least one hot exhaust outlet for removing hot exhaust from said system.

44. In accordance with claim 43, wherein said hot exhaust outlet is in driving contact with at least one portion of said condensation system to power said condensation system.

45. In accordance with claim 29, wherein said cathode is an electronically and ionically conducting material comprising doped lanthanum manganite, lanthanum-strontium-cobaltite, lanthanum-strontium ferrite, lanthanum-strontium-manganate, other doped lanthanum manganates with or without yttria stabilized zirconia, yttria stabilized zirconia, ceramics possessing perovskite structure, mixed ion-electronic conductors, and combinations comprising at least one of the foregoing materials.

46. A method for removing moisture in a fuel cell system, said method comprising the steps of:
a) connecting the moisture removal system to the fuel cell;
b) allowing exchange of heat between moisture and drying species;
c) allowing sufficient dwell time between the drying species and moisture;
d) conveying dry cathode feed gas into the fuel cell and
e) regenerating the moisture removing elements (desiccant) using hot exhaust air from said fuel cell along at least one hot air inlet.

47. In accordance with claim 46, wherein said moisture removal system is a moisture absorption system.

48. In accordance with claim 47, wherein said moisture absorption system is selected from the group consisting of physical absorption system and a chemical absorption system.

49. In accordance with claim 47, wherein said moisture absorption system is a condensation system.

50. In accordance with claim 48, wherein said physical absorption system further comprising at least one of silica gel system, molecular sieves, alumino silicates, activated carbon, rice husks, and a combination thereof.

51. In accordance with claim 48, wherein said chemical absorption system further comprising at least one of sodium sulfate, calcium chloride, calcium oxide, or combination thereof.

52. In accordance with claim 49, wherein said condensation system further comprising a refrigeration system.

53. In accordance with claim 52, wherein said refrigeration system comprises at least one refrigerant, said refrigerant comprising at least one of ammonia, freon-12, freon-22, chlorofluorocarbons, hydrochlorofluorocarbons, difluorodichloromethane, 1,1,1,2-tetrafluoroethane, isobutane, liquid carbon dioxide, liquid ethane, and a combination thereof, said refrigeration system comprising at least one of a vapor refrigeration system and a vapor absorption system.

54. In accordance with claim 47, wherein said moisture absorption system further comprising at least one hot exhaust outlet for removing hot exhaust from said system.

55. In accordance with claim 54, wherein said hot exhaust outlet is in intimate contact with at least one portion of said moisture absorption system to heat said at least one portion of said moisture absorption system for regeneration.

56. In accordance with claim 49, wherein said condensation system further comprising at least one hot exhaust outlet for removing hot exhaust from said system.

57. In accordance with claim 56, wherein said hot exhaust outlet is in driving contact with at least one portion of said condensation system to power said condensation system.
